(19) United States
(12) Patent Application Publication
(10) Pub. No.: US 2024/0425674 A1
(43) Pub. Date: Dec. 26, 2024

(54) POLYMER BLENDS HAVING IMPROVED THERMAL RESISTANCE

(71) Applicant: Dow Global Technologies LLC, Midland, MI (US)

(72) Inventors: Xiaomei Song, Shanghai (CN); Hongyu Chen, Shanghai (CN); Xuejun Liu, Shanghai (CN)

(73) Assignee: Dow Global Technologies LLC, Midland, MI (US)

(21) Appl. No.: 18/706,464

(22) PCT Filed: Nov. 3, 2022
(86) PCT No.: PCT/US2022/079200

§ 371 Date: May 1, 2024

Related U.S. Application Data
(60) Provisional application No. 63/276,253, filed on Nov. 5, 2021.

(51) Int. Cl. C08K 5/5445; C08J 3/24; C08K 5/5465

(52) U.S. Cl. CPC C08K 5/5445; C08J 3/24; C08K 5/5465; C08J 2323/08

(57) ABSTRACT

Embodiments of the present disclosure are directed to a polymeric composition comprising the cross-linked reaction product of an ionomer and a silane crosslinking agent. The ionomer may include an E/X/Y polymer where E is an ethylene monomer, X is α,β-ethylenically unsaturated carboxylic acid comonomer having 3 to 8 carbons, or its ester, and Y is alkyl acrylate or dicarboxylic acid comonomer. The ionomer comprises from 1 to 30 wt. % of X and from 0 to 40 wt. % of Y. At least a portion of the carboxyl groups of X and optionally Y are neutralized with a metal cation. The silane crosslinking agent has a formula Z((CH₂)ₐSi(OR)_{b})_{c}. Z is a mono-functional reactive group, R is an alkyl group having 1 to 4 carbon atoms or a hydrogen atom, a is from 1 to 4, b is 3, and c is from 1 to 2.

### CROSS-REFERENCE TO RELATED APPLICATION

This application claims the benefit of and priority to U.S. Application Ser. No. 63/276,253 filed on Nov. 5, 2021, and entitled “POLYMER BLENDS HAVING IMPROVED THERMAL RESISTANCE,” the entire contents of which are incorporated by reference in the present disclosure.

### TECHNICAL FIELD

Embodiments of the present disclosure generally relate to polymers, and more specifically, to ionomers.

### BACKGROUND

Thermoplastic ionomers based on poly-(ethylene-co-methacrylic acid) (“EMAA”) are used for coating and packaging applications. In these applications, high transparency, low haze, metallic luster, high mechanical modulus, and good heat resistance are required properties. Present materials can provide the required transparency, haze levels, and metallic luster at low temperatures. However, due to their lower crystallinity and lamellae thickness, they are unable to provide these properties as well as the required mechanical modulus and heat resistance. Accordingly, there remains a need for thermoplastic ionomers, which can provide the required transparency, clarity, luster, and mechanical modulus at both low and high temperatures.

### SUMMARY

Embodiments of the present disclosure address this need by providing polymeric compositions derived from the crosslinking of an E/X/Y ionomer and a silane crosslinking agent. These polymeric compositions provide improved mechanical properties at elevated temperatures, relative to conventional polymeric compositions.

In one embodiment, a polymeric composition comprises the cross-linked reaction product of an ionomer comprising E/X/Y polymer and a silane crosslinking agent. The ionomer may comprise from 1 to 30 wt. % of X and from 0 to 40 wt. % of Y. E may be an ethylene monomer, X may be an α,β-ethylenically unsaturated carboxylic acid comonomer having 3 to 8 carbons, or its ester, and Y may be an alkyl acrylate or dicarboxylic acid comonomer. At least a portion of the carboxyl groups of X and optionally Y may be neutralized with a metal cation. The ionomer may have a melt index (I₂) value (as determined by ASTM D1238, 190° C. under 2.16 kg load) of 1 to 30 g/10 min. The silane crosslinking agent may have a formula Z((CH₂)aSi(OR)b)c. Z may be a mono-functional reactive group. R may be an alkyl group having 1 to 4 carbon atoms or a hydrogen atom, a may be from 1 to 4, b may be 3, and c may be from 1 to 2.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describes various embodiments and are intended to provide an overview or framework for understanding the nature and character of the claimed subject matter. The accompanying FIGURE is included to provide a further understanding of the various embodiments, and are incorporated into and constitute a part of this specification.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a visual depiction of the heat deflection performance of some embodiments of the present disclosure.

### DETAILED DESCRIPTION

Embodiments of the present disclosure address the need for a polymeric composition with improved mechanical properties at elevated temperatures. The improved polymeric compositions include E/X/Y polymers where E is ethylene, X is an α,β-ethylenically unsaturated carboxylic acid comonomer having 3 to 8 carbons, or its ester, and Y is an alkyl acrylate or dicarboxylic acid comonomer.

### Definitions

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used herein, the term “ionomer” refers to a polymeric compound having at least some ionic groups, ionizable groups, or both.

The term “polymer” refers to a polymeric compound prepared by polymerizing monomers, whether of the same or a different type. The generic term polymer thus embraces the terms “homopolymer” and “copolymer.” The term “homopolymer” refers to polymers prepared from only one type of monomer; the term “copolymer” refers to polymers prepared from two or more different monomers, and for the purpose of this disclosure may include “terpolymers” and “interpolymer.” Trace amounts of impurities (for example, catalyst residues) may be incorporated into and/or within the polymer. A polymer may be a single polymer or a polymer blend.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used herein, min./mins. mean minutes; hr./hrs. mean hours; sec. means seconds; mol. means moles, mol. % means mole percent, wt. % means weight percent.

### EMBODIMENTS

Embodiments of the present disclosure are directed to polymeric compositions comprising the cross-linked reaction product of an ionomer and a silane crosslinking agent.

The polymeric composition may comprise from 50 to 99.5 wt. % of the ionomer and 0.5 to 20 wt. % of the silane crosslinking agent. For example, the polymeric composition may comprise from 50 to 99.5 wt. %, 60 to 99.5 wt. %, 70 to 99.5 wt. %, 80 to 99.5 wt. %, 90 to 99.5 wt. %, 95 to 99.5 wt. %, 50 to 99 wt. %, 50 to 95 wt. %, 50 to 90 wt. %, to 50 to 80 wt. %, 50 to 70 wt. %, 60 to 95 wt. %, 70 to 90 wt. %, or any combination thereof, of the ionomer and from 0.5 to 20 wt. %, from 1 to 20 wt. %, from 5 to 20 wt. %, from 10 to 20 wt. %, from 0.5 to 15 wt. %, from 0.5 to 10 wt. %, from 0.5 to 5 wt. %, from 0.5 to 2 wt. W, fro 1 to 19 wt. %, from 5 to 15 wt. %, or any combination thereof, of the silane crosslinking agent. Moreover, in addition to the cross-linked reaction product of ionomer and silane crosslinking agent, it is contemplated that the polymeric composition may comprise additional components for example, polymers, ionomers, additives, and the like.

The ionomer may be an E/X/Y polymer, where E may be an ethylene monomer, X may be an α,β-ethylenically unsaturated carboxylic acid comonomer, and Y may be an alkyl acrylate or dicarboxylic acid comonomer. One possible example of an ionomer is the one shown in structure 1.

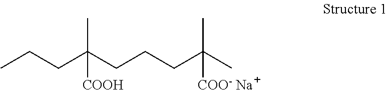

The ionomer may comprise from 30 to 99 wt. % of ethylene monomer. For example, the ionomer may comprise from 40 to 99 wt. %, from 50 to 99 wt. %, from 60 to 99 wt. %, from 70 to 99 wt. %, from 80 to 99 wt. %, from 90 to 99 wt. %, from 95 to 99 wt. %, from 97 to 99 wt. %, 40 to 95 wt. %, from 50 to 95 wt. %, from 60 to 95 wt. %, from 70 to 95 wt. %, from 80 to 95 wt. %, from 90 to 95 wt. %, from 50 to 90 wt. %, from 60 to 80 wt. %, or any combination thereof. In another embodiment, the ionomer may comprise greater than 50 wt. % of the ethylene monomer.

X may be an α,β-ethylenically unsaturated carboxylic acid comonomer having 3 to 8 carbons, or its ester. For example, X may include from 3 to 7, 3 to 6, 3 to 5, 3 to 4, 4 to 8, 4 to 7, 4 to 6, 4 to 5, 5 to 8, 5 to 7, 5 to 6, 6 to 8, 6 to 7 or 7 to 8 carbon atoms. According to specific embodiments, X may be an acrylic acid or methacrylic acid.

The ionomer may comprise from 1 to 30 wt. % of X. For example, the ionomer may comprise from 1 to 25 wt. %, from 1 to 20 wt. %, from 1 to 10 wt. %, from 1 to 6 wt. %, from 1 to 5 wt. %, from 2 to 30 wt. %, from 2 to 20 wt. %, from 2 to 10 wt. %, from 5 to 30 wt. %, from 5 to 20 wt. %, from 10 to 30 wt. %, from 10 to 20 wt. %, from 20 to 30 wt. %, or any combination thereof, of X.

Y may be an alkyl acrylate or dicarboxylic acid comonomer. The alkyl acrylate may be, by way of example and not limitation, ethyl acrylate, n-butyl acrylate, iso-butyl acrylate, or combinations thereof. In various embodiments, the alkyl acrylate has an alkyl group with from 1 to 8 carbons. This is designated a C₂-C₈-alkyl acrylate. Dicarboxylic acid comonomers may include maleic acid monoethyl ester (MAME), maleic anhydride mono-propyl ester, maleic anhydride mono-ethyl ester, maleic anhydride mono-butyl ester, or combinations thereof, and C₁-C₄-alkyl half esters of these acids, as well as anhydrides of these acids including maleic anhydride, maleic anhydride mono-methyl ester, maleic anhydride mono-ethyl ester, and itaconic anhydride.

The ionomer may comprise from 0 to 40 wt. % of Y. For example, the ionomer may comprise from 0 to 35 wt. %, from 0 to 30 wt. %, from 0 to 25 wt. %, from 0 to 20 wt. %, from 0 to 10 wt. %, from 0 to 5 wt. %, from 0 to 1 wt. %, from 0 to 0.1 wt. %, from 0.1 wt. % to 40 wt. % from 1 to 40 wt. %, from 1 to 30 wt. %, from 1 to 20 wt. %, from 1 to 10 wt. %, from 1 to 5 wt. %, from 5 to 40 wt. %, from 5 to 30 wt. %, from 5 to 20 wt. %, from 5 to 10 wt. %, or any combination thereof, of Y. According to some embodiments, the ionomer may not include any Y.

At least a portion of the carboxyl groups of X may be neutralized with a metal cation. For example at least 1, at least 2, at least 3, from 1 to 4, from 1 to 3, from 1 to 2, all except 1, or all of the carboxyl groups of X may be neutralized with the metal cation.

At least a portion of the carboxyl groups of Y may be neutralized with a metal cation. For example at least 1, at least 2, at least 3, from 1 to 4, from 1 to 3, from 1 to 2, all except 1, or all of the carboxyl groups of Y may be neutralized with the metal cation.

The metal cation may comprise any metal cation. For example, the metal cation may comprise Na, Zn, Cu, Ca, Mg or combinations thereof. Without being limited by theory, it is believed that neutralizing the carboxyl groups of the comonomer may decrease the reactivity of the comonomer. This decreased reactivity is believed to result in improved final characteristics, such as gelling, melt strength, and opacity.

The ionomer may have a melt index (I₂) value (as determined by ASTM D1238, 190° C. under 2.16 kg load) of 1 to 30 g/10 min. For example, the ionomer may have a melt flow index of from 1 to 25 g/10 min., from 1 to 20 g/10 min., from 1 to 15 g/10 min., from 1 to 10 g/10 min., from 1 to 5 g/10 min., from 5 to 30 g/10 min., from 10 to 30 g/10 min., from 15 to 30 g/10 min., from 20 to 30 g/10 min., from 25 to 30 g/10 min., from 5 to 25 g/10 min., from 10 to 20 g/10 min., or any combination thereof

The ionomer may be electrically conductive. For example, the ionomer may have an electrical conductivity of at least 0.00001 S·m⁻¹, 0.0001 S·m⁻¹, 0.001 S·m⁻¹, 0.01 S·m⁻¹, 0.1 S·m⁻¹, 1.0 S·m⁻¹, or even 10.0 S·m⁻¹.

The ionomer may conduct ions. For example, the ionomer may have an ionic conductivity of at least 0.00001 S·cm⁻¹, 0.0001 S·cm⁻¹, 0.001 S·cm⁻¹, 0.01 S·cm⁻¹, 0.1 S·cm⁻¹, 1.0 S·cm⁻¹, or even 10.0 S·cm⁻¹.

The ionomer may have a density of from 0.950 to 0.980 g/cc. For example, the ionomer may have a density of from 0.950 to 0.970 g/cc, from 0.950 to 0.960 g/cc, from 0.960 to 0.980 g/cc, from 0.960 to 0.970 g/cc, from 0.970 to 0.980 g/cc, or any combination thereof.

The ionomer may be crosslinked with a silane crosslinking agent to form the polymeric composition. The silane crosslinking agent may have the formula Z((CH₂)ₐSi(OR)_{b})_{c}. Z is a mono-functional reactive group; a may be from 1 to 4; b may be 3; and c may be from 1 to 2.

The silane crosslinking agent may include a mono-functional reactive group Z. As used herein, a mono-functional reactive group may refer to any group which forms a single bond with that monomer's repeating unit when incorporated into a polymer. For example, Z may comprise a secondary amine group (—NH) or an isocyanate group (—N═C═O)).

R may be an alkyl group having 1 to 4 carbon atoms or a hydrogen atom. For example, R may be an alkyl group having 1 to 2, 1 to 3, or 2 to 4 carbon atoms.

Structure 2 shows a silane crosslinking agent of the present disclosure where R is an alkyl group with 1 carbon atom, a is 3, b is 3, e is 1, and Z is a cyano-group.

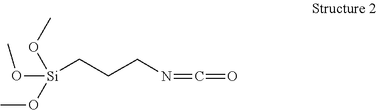

Structure 3 shows a silane crosslinking agent of the present disclosure where R is an alkyl group having 1 carbon atom, a is 3, e is 2, and Z is a secondary amine group.

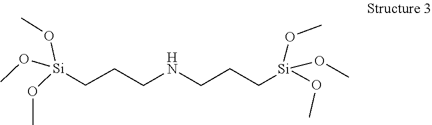

The blend can additionally include small amounts of additives including nanofillers, plasticizers, stabilizers including viscosity stabilizers, hydrolytic stabilizers, primary and secondary antioxidants, ultraviolet light absorbers, anti-static agents, dyes, pigments or other coloring agents, inorganic fillers, fire-retardants, lubricants, reinforcing agents such as glass fiber and flakes, synthetic (for example, aramid) fiber or pulp, foaming or blowing agents, processing aids, slip additives, antiblock agents such as silica or talc, release agents, tackifying resins, or combinations of two or more thereof. Inorganic fillers, such as calcium carbonate, and the like can also be incorporated into the blend.

These additives may be present in the blends in quantities ranging from 0.01 to 40 wt %, 0.01 to 25 wt %, 0.01 to 15 wt %, 0.01 to 10 wt %, or 0.01 to 5 wt %. The incorporation of the additives can be carried out by any known process such as, for example, by dry blending, by extruding a mixture of the various constituents, by the conventional masterbatch technique, or the like.

The ionomer may be prepared by standard free-radical copolymerization methods, using high pressure, operating in a continuous manner. Monomers are fed into the reaction mixture in a proportion, which relates to the monomer's activity, and the amount desired to be incorporated. In this way, uniform, near-random distribution of monomer units along the chain is achieved. Unreacted monomers may be recycled. Additional information on the preparation of ethylene acid copolymers including the softening monomer can be found in U.S. Pat. Nos. 3,264,272 and 4,766,174, each of which is hereby incorporated by reference in its entirety.

A method of making the polymeric composition of the present disclosure may include soaking the ionomer with the silane crosslinking agent to cross-link the ionomer and the silane cross-linking agent.

The ionomer may be soaked with the silane crosslinking agent at a temperature of from 30° C. to 100° C., such as from 40° C. to 80° C., from 40° C. to 60° C., from 50° C. to 80° C., or any combination thereof.

The ionomer may be soaked with the silane crosslinking agent for at least 1 hr., such as for at least 2 hr., at least 4 hr., at least 8 hr., at least 16 hr., at least 24 hr., or any combination thereof.

According to some embodiments, the polymeric composition may further comprise a moisture cure catalyst. The moisture cure catalyst may include, but is limited to, zirconium compounds, titanium compound, zinc compounds, or combinations of these. The zirconium compounds may include zirconium octoate, zirconium acetate, or both. The titanium compounds may include titanium(IV) butoxide. The zinc compound may include zinc octoate, zinc acetate, or both. The polymeric composition may comprise from 0.01 to 1 wt. %, from 0.01 to 0.8 wt. %, from 0.05 to 1 wt. %, from 0.05 to 0.6 wt. % from 0.1 to 1 wt. %, from 0.1 to 0.8 wt. %, from 0.1 to 0.6 wt. %, from 0.1 to 0.4 wt. %, or any combination thereof, of the moisture cure catalyst.

According to some embodiments, the polymeric composition may comprise nanofillers. Nanofillers may include a filling agent with one of three dimensions measuring less than 100 nm. For example, nanofillers may include, but are not limited to, silica, borate nitride, zinc oxide, aluminum oxide and titanium dioxide. The particle size of the filler may be from 10 to 300 nanometers. For example, the particle size of the nanofillers may be from 10 nm to 100 nm, from 20 nm to 75 nm, or from 20 nm to 50 nm. When the polymeric composition comprises nanofillers, the polymeric composition may comprise from 0.1 to 10 wt. %, from 1 to 10 wt. %, from 5 to 10 wt. %, from 0.1 to 8 wt. %, from 0.1 to 5 wt. %, from 0.1 to 3 wt. %, from 0.1 to 1 wt. %, from 1 to 9 wt. %, from 2 to 8 wt. %, from 4 to 6 wt. %, or any combination thereof.

According to some embodiments of the present disclosure, an injection molded article may include the polymeric composition of the present disclosure.

### Test Methods

### Vicat Softening Point

Vicat softening point is the temperature at which a flat-end needle penetrates the specimen to a depth of 1 mm under a specific load. Vicat softening point was measured according to ISO 306:2013. Generally, the testing procedure was follows. A flat sample with a surface of 10 mm×10 mm and a thickness either 3 mm or 6 mm was placed into the tester. A load of 10 N was applied to the sample through a needle. This setup was placed into an oil bath and heated at a speed of 120° C./hr. until the needle penetrated 1 mm into the sample.

### Density

Density was measured in accordance with ASTM D792, and expressed in grams/cm³ (g/cm³).

### Melt Index (I₂)

Melt Index was measured in accordance with ASTM D 1238-10 at 190 Celsius and 2.16 kg, Method B, and is expressed in grams eluted/10 minutes (g/10 min).

### DSC Method

Differential scanning calorimetry (DSC) is used to examine the melting and crystallization of semi-crystalline polymers. General principles of DSC measurements and applications of DSC to studying semi-crystalline polymers are described in standard texts (e.g., E. A. Turi, ed., Thermal Characterization of Polymeric Materials, Academic Press, 1981).

In preparation for Differential Scanning Calorimetry (DSC) testing, pellet-form samples were first loaded into a 1 in. diameter chase of 0.13 mm thickness and compression molded into a film under 25,000 lbs of pressure at 190° C. for approximately 10 seconds. The resulting film was then cooled to room temperature. After which, the film was subjected to a punch press in order to extract a disk that will fit the DSC test pan (Aluminum Tzero). The disk was weighed (note: sample weight is approximately 5-6 mg) and placed into the aluminum Tzero pan and sealed before being inserted into the DSC test chamber.

In accordance to ASTM standard D3418, the DSC test was conducted using a heat-cool-heat cycle. First, the sample was equilibrated at 180° C. and held isothermally for 5 min. to remove thermal and process history. The sample was then quenched to −40° C. at a rate of 10° C./min. and held isothermally once again for 5 min. during the cool cycle. Lastly, the sample was heated at a rate of 10° C./min. to 150° C. for the second heating cycle. For data analysis, the melting temperatures and enthalpy of fusion were extracted from the second heating curve, whereas the enthalpy of crystallization is taken from the cooling curve. The enthalpy of fusion and crystallization were obtained by integrating the DSC thermogram from −20° C. to the end of melting and crystallization, respectively. The tests were performed using the TA Instruments Q2000 and Discovery DSCs, and data analyses were conducted via TA Instruments Universal Analysis and TRIOS software packages.

### Storage Modulus or DMTA (Modulus Testing by Dynamic Mechanical Thermal Analyzer) According to ISO Standard 4664-1

The storage modulus is a measure of the amount of energy stored when distorting a sample. The storage modulus was measured according to ISO 4664-1. To measure the storage modulus, compressed, 6″×0.5″×0.125″ bars are placed them in a RSA-G2, TA Instruments. The test temperature was set as 20° C.˜150° C. with a ramp rate of 3° C./min. The angular frequency was set to be 6.28 rad/s, strain was set to be 0.1%. he analyzer was then set to Dynamic Temperature Ramp Frequency: 6.28 rad/s, Initial Temp: 20.0° C., Final Temp: 150.0° C., and Ramp Rate=3.0° C./min.

### EXAMPLES

A series of comparative and inventive examples were prepared by combining the polymer of Table 1 with the silanes of Table 1.

TABLE 1
Selected Polymers and Silanes

| Ingredient | | |
|---|---|---|
| Type | Product Name and/or Description | Chemical Description, Chemical formula, or Structure |
| Ionomer 1 | Ionomer 1, which was produced in accordance with above described free radical polymerization process, is a partially neutralized copolymer of ethylene (85 wt.%) and methacrylic acid (15 wt. %). The neutralization metal cation is sodium. | 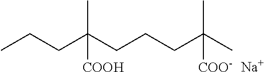 |
| | Ionomer 1 has a density of 0.960 and an I₂ of 4.5 | |
| | g/10 mins. | |
| Silane 1 | Trimethoxy(octyl)silane, Long alkyl silane, CAS number: 3069-40-7 | 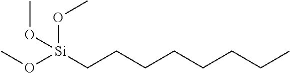 |
| Silane 2 | 1,10-Bis-Trimethoxysilyl Decane, CAS number: 122185-09-5 | 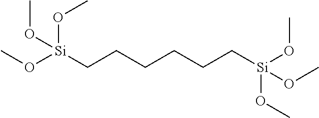 |
| Silane 3 | (3-Aminopropyl)triethoxysilane, Amino silane, CAS number: 919-30-2 | 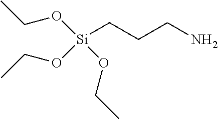 |
| Silane 4 | [3-(2-Aminoethylamino)propyl]trimethoxysilane, Amino silane, CAS number: 1760-24-3 | 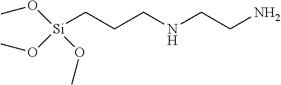 |
| Silane 5 | 3-Glycidoxypropyldimethoxymethylsilane, Epoxy silane, CAS number: 65799-47-5 | 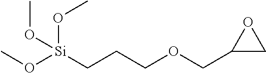 |
| Silane 6 | 3-(Triethoxysilyl)propyl isocyanate, Isocyanate silane, CAS number: 15396-00-6 | 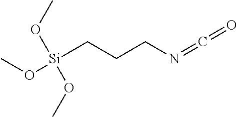 |
| Silane 7 | Bis[3-(trimethoxysilyl)propyl]amine, Amino silane, CAS number: 82985-35-1 | 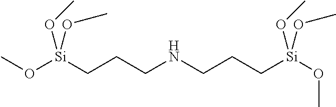 |

### Sample Preparation

Ionomer pellets were soaked with the silane molecules at 50° C. for 24 hours in a sealed jar. After soaking, the ionomer pellets were thermally compressed at 180° C. for 30 min. to form a bar of 10 mm×10 mm×6 mm.

As specifically identified, selected formulations were injection molded at around 240° C. to make thinner plaques (3 mm thickness) for thermal resistance testing and clarity evaluation.

The resulting sample formulations are given in Table 2 below. CE refers to comparative example and IE refers to inventive example.

TABLE 2

| Ingredient | CE1 | CE2 | CE3 | CE4 | CE5 | CE6 | IE1 | IE2 | IE3 | IE4 |
|---|---|---|---|---|---|---|---|---|---|---|
| Polymer 1 (g) | 100.0 | 90.0 | 98.0 | 98.0 | 98.0 | 98.0 | 98.0 | 95.0 | 98.0 | 95.0 |
| Silane 1 (g) | | 10.0 | | | | | | | | |
| Silane 2 (g) | | | 2.0 | | | | | | | |
| Silane 3 (g) | | | | 2.0 | | | | | | |
| Silane 4 (g) | | | | | 2.0 | | | | | |
| Silane 5 (g) | | | | | | 2.0 | | | | |
| Silane 6 (g) | | | | | | | 2.0 | 5.0 | | |
| Silane 7 (g) | | | | | | | | | 2.0 | 5.0 |
| Total (g) | 100.0 | 100.0 | 100.0 | 100.0 | 100.0 | 100.0 | 100.0 | 100.0 | 100.0 | 100.0 |

The samples were then evaluated for transparency, Vicat softening point, TM1*DSC, and storage modulus, as is given in Table 3.

TABLE 3
Properties and Performance

| Property | CE1 | CE2 | CE3 | CE4 | CE5 | CE6 | IE1 | IE2 | IE3 |
|---|---|---|---|---|---|---|---|---|---|
| Transparency/ | 5 | 1 | 1 | 3 (bubble) | 3 (bubble) | 1 | 5 | 5 | 5 |
| clarity (1-5, | | | | | | | | | |
| higher is | | | | | | | | | |
| better) | | | | | | | | | |
| Vicat softening | 59.2 | N/A | N/A | N/A | N/A | N/A | 70.7 | 69.9 | 71.4 |
| point (° C.) | | | | | | | | | |
| Tm1* (DSC) | 49.0 | 50.1 | 52.5 | 50.3 | 51.3 | 50.6 | 54.6 | 54.0 | 54.2 |
| (° C.) | | | | | | | | | |
| Storage | 7 × 10⁶ | N/A | N/A | N/A | N/A | N/A | 3 × 10⁷ | 3 × 10⁷ | 4 × 10⁷ |
| modulus at | | | | | | | | | |
| 80° C. (DMTA) | | | | | | | | | |

As referenced in Table 3, a transparency of 5 is ideal. Tm1*(DSC) is the first melting peak on the differential scanning calorimetry (“DSC”) curve. L. Tm1*DSC is understood to correspond to the melting temperature of secondary crystallites among ionic clusters.

As is shown in Table 3, Silanes with mono-reactive groups, such as secondary amines or isocyanate groups, when reacted with the residual carboxyl group of Polymer 1 to form ionomers (IE 1-3), exhibit improved crosslinking and thus improved physical properties relative to the comparative examples. Improvements can be seen in all of Vicat softening point, Tm1*DSC (melting point), and storage modulus.

Sample bars CE2-CE6 could not be tested for Vicat softening point or storage modulus (DMTA) because the sample bars failed to form properly.

Comparative examples CE2 and CE3 were prepared from silanes without any additional reactive groups. These examples appeared to have insufficient reactivity, resulting in excessive opacity and thus were unfit for use.

Comparative examples CE4, CE5, and CE6 were prepared from silanes with more reactive groups, such as primary amine groups or epoxy groups. This resulted in opacity issues and processability issues, which precluded their use. Processability issues included bubbling during formation and gelling during compounding. Without being limited by theory, it is believed that the opacity issues are due to the reactive compatibilization effect.

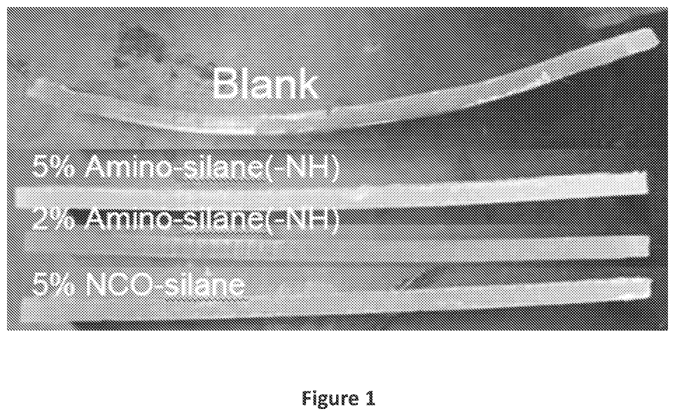

The heat deflection performance of the inventive examples was tested by heating a 6″×0.5″×0.125″ sample using a three point bending test. Specifically, both ends of the sample were supported and a 500 g weight was placed in the middle of the sample. The sample was then heated to 100° C. for 30 min. Referring now to FIG. 1, CE1 110 exhibited extreme deflection of about 300 while IE4 120, IE3 130, and IE2 140 showed minimal deflection of less than 5°.

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A polymeric composition comprising the cross-linked reaction product of:
an ionomer comprising E/X/Y polymer wherein:
the ionomer comprises from 1 to 30 wt. % of X and from 0 to 40 wt. % of Y,
E is ethylene monomer,
X is an α,β-ethylenically unsaturated carboxylic acid comonomer having 3 to 8 carbons, or its ester, and
Y is an alkyl acrylate or dicarboxylic acid comonomer;
wherein at least a portion of the carboxyl groups of X and optionally Y are neutralized with a metal cation, and the ionomer has a melt index (I₂) value (as determined by ASTM D1238, 190° C. under 2.16 kg load) of 1 to 30 g/10 min; and
a silane crosslinking agent having a formula Z((CH₂)ₐSi(OR)_{b})_{c}, wherein: Z is a mono-functional reactive group; R is an alkyl group having 1 to 4 carbon atoms or a hydrogen atom; a is from 1 to 4; b is 3; and c is from 1 to 2.

2. The polymeric composition of claim 1, wherein X is acrylic acid or methacrylic acid.

3. The polymeric composition of claim 1, wherein the metal cation comprises Na, Zn, Cu, Ca, Mg or combinations thereof.

4. The polymeric composition of claim 1, wherein Z comprises a secondary amine group (—NH) or an isocyanate group (—N═C═O)).

5. The polymeric composition of claim 1, wherein R is an alkyl group having 1 to 2 carbon atoms.

6. The polymeric composition of claim 1, wherein the ionomer comprises greater than 50 wt. % of ethylene monomer.

7. The polymeric composition of claim 1, wherein the polymeric composition comprises 50 to 99.5 wt. % of the ionomer and 0.5 to 20 wt. % of the silane crosslinking agent.

8. The polymeric composition of claim 1, wherein the polymeric composition further comprises moisture cure catalyst.

9. The polymeric composition of claim 1, wherein the ionomer has a density of 0.950 to 0.980 g/cc.

10. An injection molded article comprising the polymeric composition of claim 1.

11. A method of making the polymer composition of claim 1 comprising:
soaking the ionomer in a solution comprising the silane crosslinking agent to cross-link the ionomer and the silane cross-linking agent.
